(19) United States
(12) Patent Application Publication
(10) Pub. No.: US 2013/0046422 A1
(43) Pub. Date: Feb. 21, 2013

(54) ONBOARD FLIGHT PLANNING SYSTEM

(71) Applicant: Ralf Cabos, Singapore (SG)

(72) Inventor: Ralf Cabos, Singapore (SG)

(73) Assignee: FLIGHT FOCUS PTE. LTD., (SG)

(21) Appl. No.: 13/640,707

(22) PCT Filed: Apr. 12, 2011
(86) PCT No.: PCT/IB11/51559

§ 371 Date: Oct. 11, 2012

(30) Foreign Application Priority Data
Apr. 12, 2010 (IB) PCT/IB2010/051557

(51) Int. Cl. G08G 5/00

(52) U.S. Cl. 701/3; 701/120

(57) ABSTRACT

According to the application, a method for generating a flight route of an aircraft by an aircraft based computer system is disclosed. The method comprises the execution the following steps, which are executed by the aircraft based computer system. A mission specific data subset is received from a ground system. It is checked whether there are predefined routes from a departure airport to a destination airport. If it is determined that predefined route are available which are in accordance with over-flight permissions the predefined routes are used as a set of candidate routes for deriving a flight route. Otherwise, a set of proposed flight routes is generated which comprises at least one proposed flight route. Over-flight permissions are checked for the set of proposed flight routes. The steps of generating a set of proposed flight routes and of checking the over-flight permissions are repeated until at least one proposed flight route is found to be in accordance with the over-flight permissions. The one or more flight routes or routes which are in accordance with the over-flight permissions are used as a set of candidate routes for deriving a flight route. A flight route is derived from the set of candidate routes.

The present application relates to a flight planning system for producing a flight plan onboard an aircraft. A flight plan includes a description of a proposed flight route and is closely associated with other information such as a flight schedules and aircraft schedules, weight and balance, and crew rostering plans etc. Flight planning involves two safety-critical aspects: fuel calculation to ensure there is adequate fuel for the flight, and compliance with air traffic control requirements, to minimise the risk of mid-air collision. In addition, planners normally wish to minimise flight cost by careful consideration of the choice of route, height, and speed, by loading the maximum amount of passengers and cargo on board, and by loading the minimum fuel necessary for the flight.

Accurate weather forecasts are required so that fuel consumption calculations can account for the rate at which the fuel is likely to be consumed, considering the effects of head or tail winds and air temperature. Safety regulations require aircraft to carry fuel beyond the minimum needed to fly from origin to destination, allowing for unforeseen circumstances or for diversion to another airport if the planned destination becomes unavailable. Aircraft flying in controlled airspace are under the supervision and direction of air traffic control and must follow predetermined routes known as airways, unless the flight crew is instructed to fly in another way, for example if the flight is given track shortening. When operating in controlled or uncontrolled airspace, aircraft must maintain specific flight levels, or altitudes usually separated vertically by 1000 or 2000 feet (305 or 610 m). These specific flight levels or altitudes are related to the direction of flight. When aircraft with only two engines are flying across oceans, they have to satisfy extra safety rules to ensure that such aircraft can reach an emergency airport if one engine fails, experiences cabin depressurisation, or both.

Producing an accurate optimised flight route requires a large number of complex calculations using a large amount of data and information. Commercial flight planning systems make extensive use of ground-based computers. Some commercial airlines have their own internal flight planning system, while others employ the services of external planners. Because of the number of computations, the amount of data and information, and the amount of computing power required, flight planning systems for commercial airlines are usually operated as ground-based equipment by specially trained staff members.

Modern aircraft often provide a flight management system which allows the pilot to manually enter a precomputed flight route by means of a keyboard. The entered data, such as waypoints and flight levels, is shown in a textual form on a control display unit (CDU) as well as on a simple two-dimensional multifunction display. The multifunction display shows basic navigational elements from a navigational database and the flight route of the aircraft, as manually entered by the pilot. The navigational database is updated according to a 28 day update cycle known as the AIRAC Cycle which is a cycle published by the International Civil Aviation Organization (ICAO) and comprises information such as waypoints, navigation aids, airways, airport information, holding patterns, standard instrument departures (SID) and standard terminal arrival routes (STAR). SIDs and STARs may also be entered manually by transferring information from a paper chart. Then, care must be taken to extract the right information from the right chart. This may become necessary if the charts have been changed between 28 day update cycles as is the case when a NOTAM or other change document has been issued by a State. To speed up data input, the navigational database may also contain precomputed company routes.

It is an object of the present application to provide improved methods and devices for onboard flight planning.

According to the application, a method for generating a flight route of an aircraft by an aircraft based computer system is disclosed. The method comprises the execution the following steps, which are executed by the aircraft based computer system. A mission specific data subset is received from a ground system If the plane is on the ground, a Bluetooth connection or a data carrier such as a USB stick may be used, whereas a satellite collection or a direct radiowave link may be used when the plane is in the air. It is checked whether there are predefined routes from a departure airport to a destination airport in a computer readable memory of the aircraft based system. The predefined routes comprise company routes and stored routes. The checking for predefined routes may also take into account prescribed waypoints and flights with multiple flight legs. If it is determined that predefined route are available which are in accordance with over-flight permissions the predefined routes are used as a set of candidate routes for deriving a flight route.

Otherwise, a set of proposed flight routes is generated which comprises at least one proposed flight route. Over-flight permissions are checked for the set of proposed flight routes. The steps of generating a set of proposed flight routes and of checking the over-flight permissions are repeated until at least one proposed flight route is found to be in accordance with the over-flight permissions. In the generation step, routes which have been discarded in a previously executed step are excluded. The amount of possible proposed routes is large enough to guarantee that a route which is in accord with the over-flight permissions will always be found. The one or more flight routes which are in accordance with the over-flight permissions are used as a set of candidate routes for deriving a flight route. A flight route is derived from the set of candidate routes.

Herein and in the following, “checking” includes comparing data against a condition or against other data and outputting a value which indicates whether the condition is met or whether the data matches with the other data according to predetermined criteria.

According to a further aspect of the application, the deriving of a flight route comprises checking the acceptability of the set of candidate routes according to a predetermined set of conditions. The predetermined set of conditions comprises, among others, NOTAM, regulations, restrictions, weather conditions, and for timing of the flight when this is required to meet specific departure, en route or arrival times.

If it is determined that none of the candidate routes is acceptable the following steps are repeated until at least one acceptable candidate route is found. A new set of candidate routes is generated by creating alternative proposed routes or by selecting alternative stored routes. “Alternative” in this context means that routes are excluded which have been found not acceptable or not in accordance with the over-flight permissions in previously executed steps. Similar to the abovementioned procedure, the steps of checking the over-flight permissions and of generating a set of proposed flight routes are repeated until at least one proposed flight route is found to be in accordance with the over-flight permissions. These one or more proposed flight routes are then used as a set of candidate routes and the acceptability of this new set of candidate routes is determined according to the predetermined set of conditions.

If it is determined that at least one candidate route is acceptable the acceptable candidate routes are optimized vertically and, according to an alternative embodiment, also horizontally. Based on output data of the optimizing process, a flight route is selected from the acceptable candidate routes and the flight route is stored in a computer readable memory of the aircraft based system for later output. The storage of the flight route may, for example, comprise the storage of computed waypoints, heights, departure, en route and arrival times as well as a computed fuel consumption along the route.

According to further embodiments, the selection of the flight route depends on further criteria such as the result of a cost calculation. The flight route that is selected is also referred as a “most suitable” route.

An optimization may also comprise the computation of a flight route that is only within a predetermined margin of an optimum. This means that the expression “optimum” is to be understood more generally in a sense that an improved result is seen as acceptable as long as the result is in the vicinity of a local maximum or local minimum. Furthermore it is understood that an optimum will only be achieved within the given accuracy, and within further constraints, such as, for example, computation time constraints, the input data, the chosen modelling etc. In an alternative embodiment, the optimization is configurable by adjusting the relative weight of contributing factors such as fuel consumption, cost and flight time.

Further processing of the selected flight route comprises, for example, loading the flight route into a flight management computer system of the aircraft for a generation of autopilot commands during a flight using an ARINC Bus system or displaying the flight route on a moving map display of an onboard pilot display unit or transmitting the selected flight route to an air traffic control agency, to an airline or to any other agency or service provider.

According to a further aspect of the application, the above-mentioned methods comprise a calculation of a fuel consumption for the candidate routes and a calculation of a cost for the candidate routes based on the fuel consumption. According to further embodiments, the cost calculation depends on further contributions such as over-flight fees and airport taxes.

According to another aspect of the application, the onboard flight planning system generates further output data, based on the selected flight route, such as an operational flight plan for use by a flight crew, a flight plan for use by an air traffic control service, a flight crew briefing package which contains a listing of NOTAM and weather, and other information relevant to the flight, a fuel order which comprises an amount of required fuel and details of the fuel carried onboard the aircraft, a load and balance sheet etc.

According to yet a further aspect of the application, the onboard flight planning system generates a mission specific output for use in automated flight following for the flight. More specifically, the automated flight following comprises the following steps. The ground based system receives the mission specific output data from the aircraft-based system. The mission specific output data is stored in memory of a computerised flight following system. The received data is analysed and compared with previously stored data. It is determined if the received data is different from previously stored data. If a change is required the data on board the aircraft is automatically updated. Master document lists held on both the aircraft-based and ground-based systems are resynchronized.

According to a further aspect of the application, the onboard flight planning system derives a formatted output data from an output of the flight planning application and the formatted output is transmitted to one ore more external agencies, for example an air traffic control service, an airline, a data service provider for an airline. The formatting may include formatting according to an official format, such as an ICAO format.

According to yet another aspect of the application, the set of predetermined conditions are updated based on the mission specific data subset. Data is extracted from the mission specific subset and parsed. One ore more of the predetermined conditions are derived from the parsed data. The predetermined conditions are updated based on the parsed data, which may include replacing, altering, deleting or inserting predetermined conditions.

More specifically, the abovementioned step of receiving the mission specific dataset may be carried out via a Bluetooth connection using a stationary antenna on the airport or also an antenna that is mounted to a service vehicle.

More specifically, the selection of the candidate routes may also comprise calculating the costings of the candidate route or the candidate routes. The calculation of the costing comprises retrieving or calculating charges such as airport charges, over-flight charges and other fees. The selection of candidate routes may furthermore comprise retrieving or calculating performance data of the engines of the aircraft.

The determination of acceptability of the candidate routes may furthermore comprise checking the candidate routes against weather data and calculating a preferred route of flight based on weather information.

According to the application, an aircraft based flight planning system for generating a flight route of an aircraft by an aircraft based computer system is disclosed.

The aircraft based flight planning system comprises a receiving means for receiving a mission specific data subset from a ground system, a computer readable memory for storing a set of predetermined routes and a set of predetermined over-flight permissions. It furthermore comprises a control means for determining if predetermined routes from a departure airport to a destination airport are available, the predetermined routes being stored in a computer readable memory and for outputting the predetermined routes as a set of candidate routes. A flight route generating and calculation module is provided for generating, if predefined routes are not available, a set of proposed flight routes which comprises at least one proposed flight route. The control means verifies for the set of proposed flight routes, for which of the proposed flight routes the over-flight permissions are fulfilled and repeats the steps of generating a set of proposed flight routes and of verifying the over-flight permissions until at least one proposed flight route is found to be in accordance with the over-flight permissions. The control means outputs the proposed routes which are in accordance with the over-flight permission as a set of candidate routes and derives a flight route from a set of candidate routes.

Furthermore, the aircraft based flight planning system may also comprise a fuel calculation module for calculating a fuel consumption based on a flight route and a cost calculation module for calculating a cost based on the fuel consumption and on other fees and charges.

Furthermore, the application discloses an aircraft with an aircraft based flight planning system according to the application.

According to the application, a mission data subset including current data such as weather and NOTAM (notice to airmen) is uploaded to a plane. On the basis of this mission data subset it is possible to generate a flight plan which takes into account current restrictions and which is optimized to the current weather data. The recency of information according to the application is especially advantageous if the plan to be filed to the air traffic control may be filed during the stay of a plane at the airport or even shortly before takeoff.

Even when an earlier filing of the flight plan is required, the recency of the data included in the mission data subset is still advantageous. For example, apart from weather data also additional restrictions or, on the contrary, cancelations of restrictions that were not included in the 28 day update cycle, such as communicated in NOTAM, SNOWTAM, ASHTAM and so forth are considered in the generation of a flight plan according to the application, thus the onboard flight planning system has the most recent data available to it for use in the construction of a valid flight plan. Furthermore, according to the application, significant benefits can be achieved by uploading new information during a flight and optimizing and adjusting the flight route during the flight, for example in the event of unexpected changes to a flight route or unexpected weather changes.

Moreover, the user interaction in the course of a flight planning process is simplified through the use of a mission specific data subset. Through use of the mission specific subset, the aircraft based component of the flight information system is able to selectively display only the information which is needed for a specific flight of the aircraft, for example in menus and on a moving map display, and consequently requires a substantially lesser same amount of computer processing capacity to derive a flight plan, as compared to the preparation of a flight plan using conventional flight planning techniques.

Furthermore, according to the application, the data may be uploaded via a communication link such as Bluetooth link. In this way, a manual transport of a data carrier to the plane is avoided, although the manual transport of the data to the aircraft is still possible using a USB or similar device. The uploaded data may furthermore carry an identifier for the aircraft and the flight such that the ground based component can determine the correct information to be retrieved and, on the other hand, the aircraft based system can immediately identify if the correct information has been transmitted to it.

The forwarding and synchronisation of the flight plan with a service provider's operations centre according to the application facilitates tracking and coordination of activities and flight following, which is then able to direct the most recent updates to the aircraft while in flight, thus significantly enhancing safety. Activities of an airline back office may be largely automated and outsourced to the service provider which is especially advantageous for small airlines, or to those wishing to achieve different economic outcomes.

According to the application, it is determined prior to upload which data applies to a given flight or plane and the data is collected in a mission data subset so that the data to be uploaded is rationalised and minimized. On the other hand, this provides the opportunity to download a greater amount of relevant information for the given flight. Moreover, previous updates are considered, so that only an incremental update of the onboard data is necessary.

According to the application, an operational flight plan as well as an ATC (air traffic control) flight plan is generated automatically and the ATC flight plan is send to the responsible ATC agencies. Manual entering and editing of information for flight plans is no longer necessary and possible errors from manual entering are avoided, although additional information may be provided by the flight crew as well.

According to the application, the flight route is generated taking into account the actual loading of the airplane, as provided in the mission data subset. Amongst other things this allows for additional optimization and cost saving, as compared to a pre-computed flight route using standardised data.

Furthermore, flight routes can be generated onboard the plane such that an optimized flight route is always available, in contrast to the more common method of generating a flight plan using ground-based computing systems and personnel. According to the application, several candidate flight routes are compared and an optimal route is selected from the candidate routes. Especially when the optimization function is nonlinear, restrictions cannot easily be accounted for from the outset and a selection from several candidate routes, as in the present application, is advantageous to find an optimal route. Herein, “optimal” also comprises the meaning of optimal within a predefined margin.

Furthermore, the outputs from the onboard flight planning system are able to be depicted in the onboard pilot display units which include a moving map display. The depiction of the route of the flight as derived by the flight planning engine is able to be displayed on a moving map display in conjunction with operational aspects such as weather and NOTAM information so that the flight crew are able to relate the route of the flight and the operational conditions on the one display which is part of the overall flight information system.

In the following, the present application is explained in more detail with reference to the following figures in which

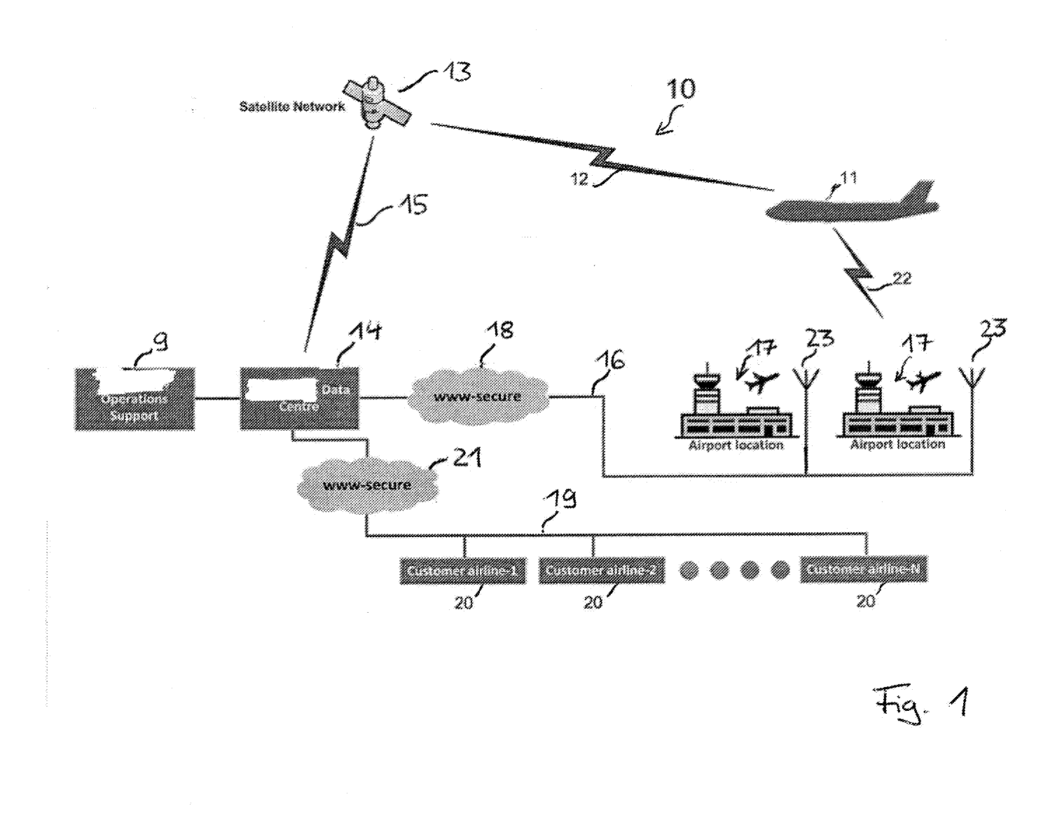

FIG. 1 illustrates a flight information exchange system,

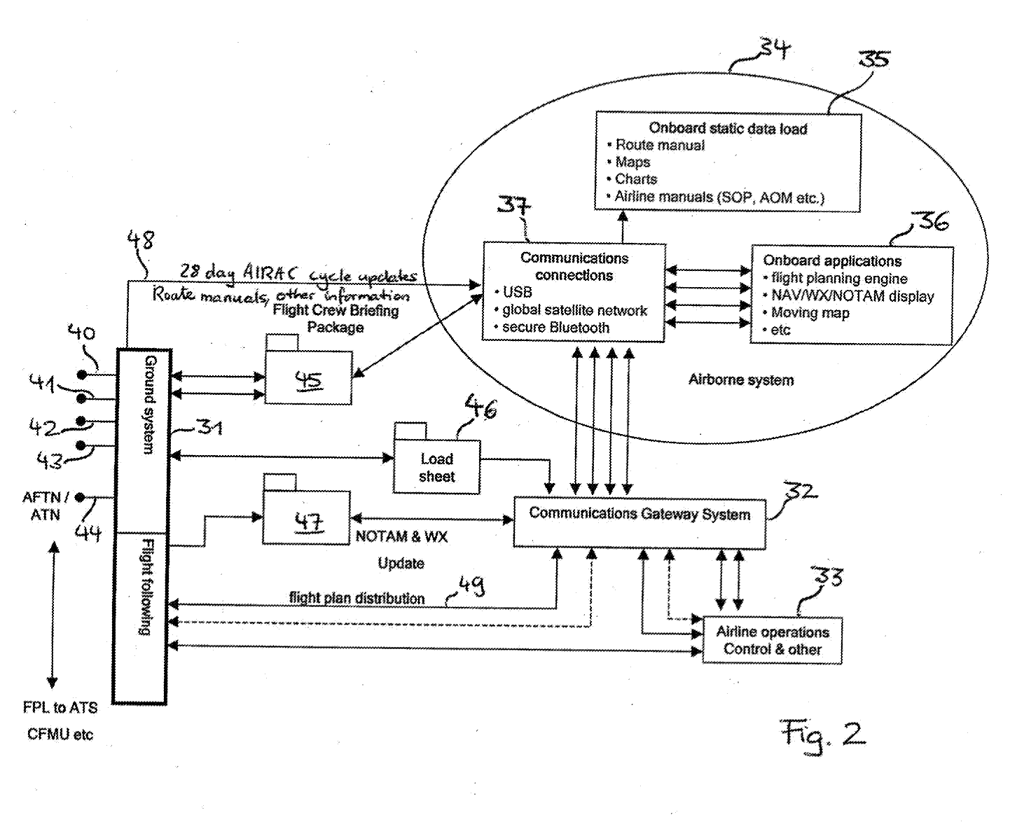

FIG. 2 illustrates a data exchange diagram of the flight information system of FIG. 1,

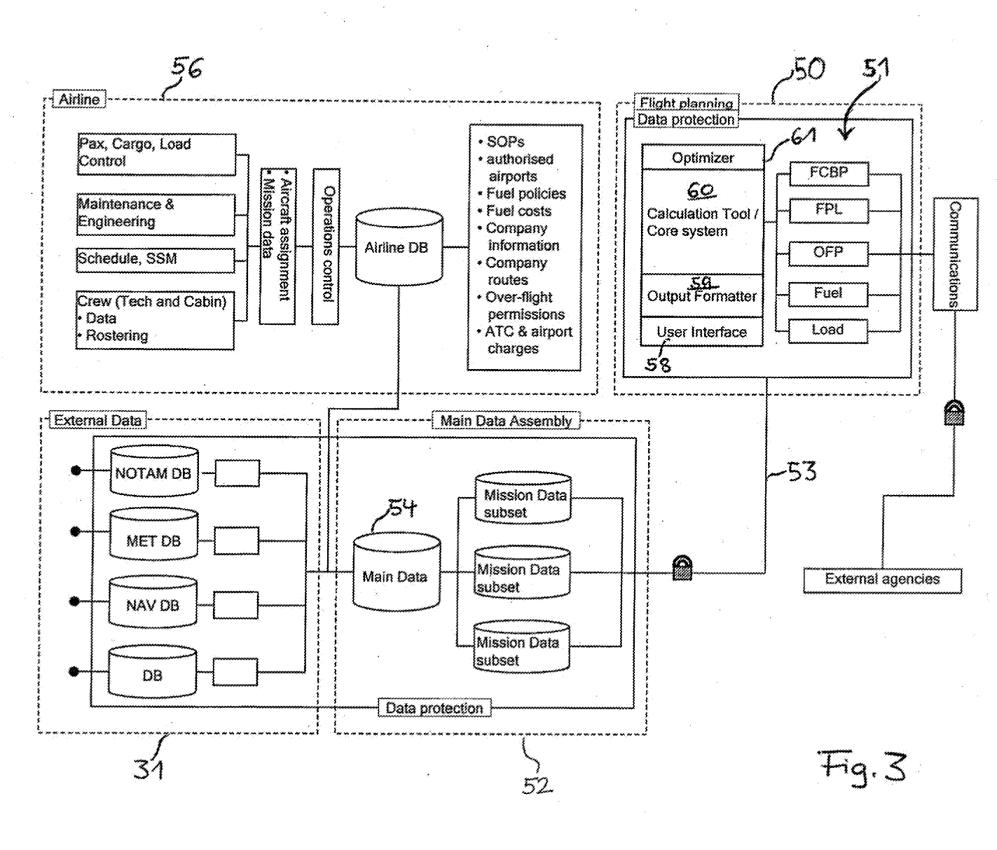

FIG. 3 illustrates a data exchange diagram of a flight planning system,

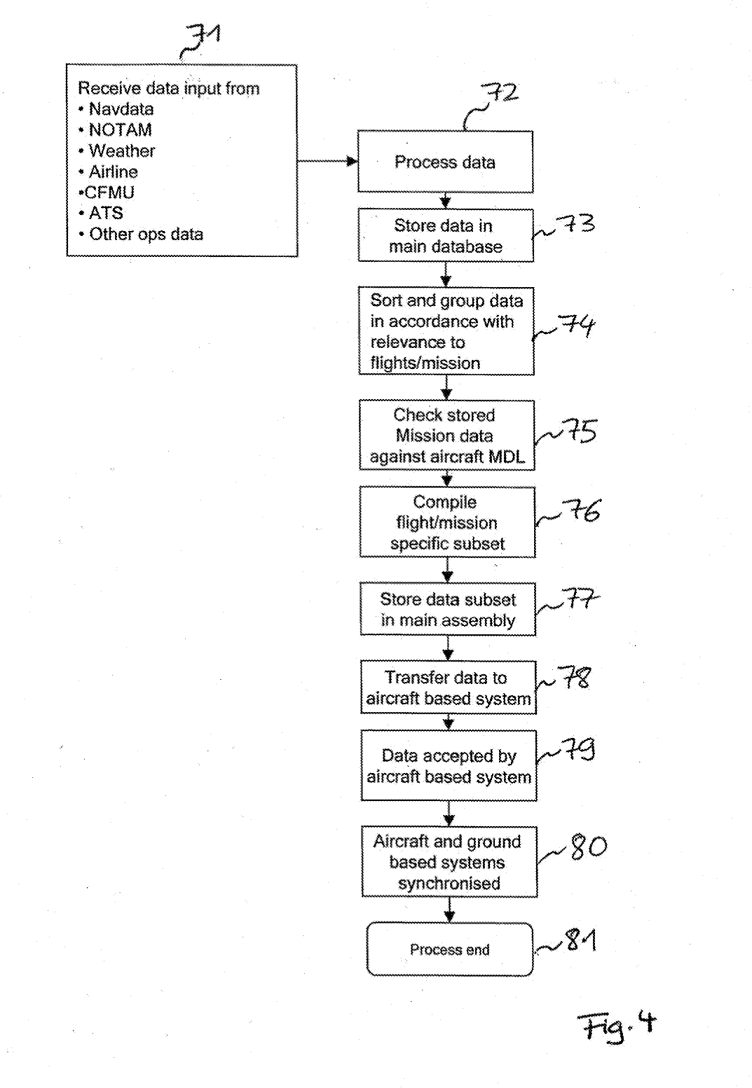

FIG. 4 illustrates a processing of data on a ground based component and uploading of mission specific data to an aircraft,

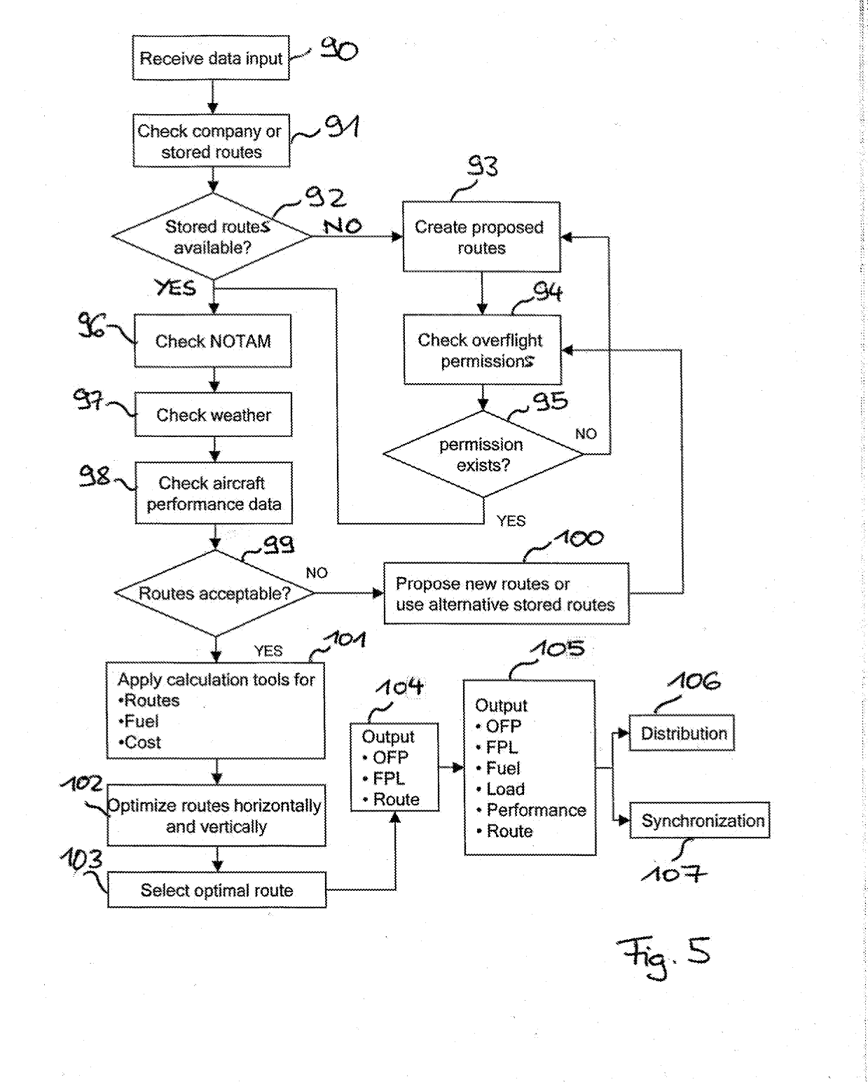

FIG. 5 illustrates a flight route calculation based on the uploaded data,

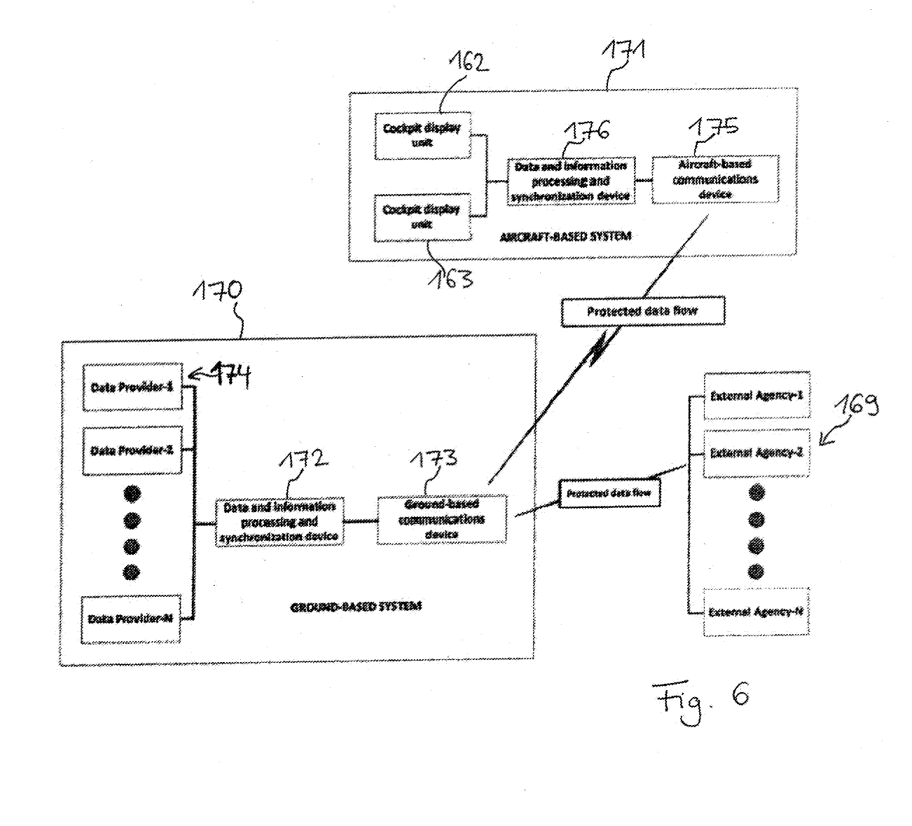

FIG. 6 illustrates data flows between a ground based system, an aircraft based system and external agencies, and

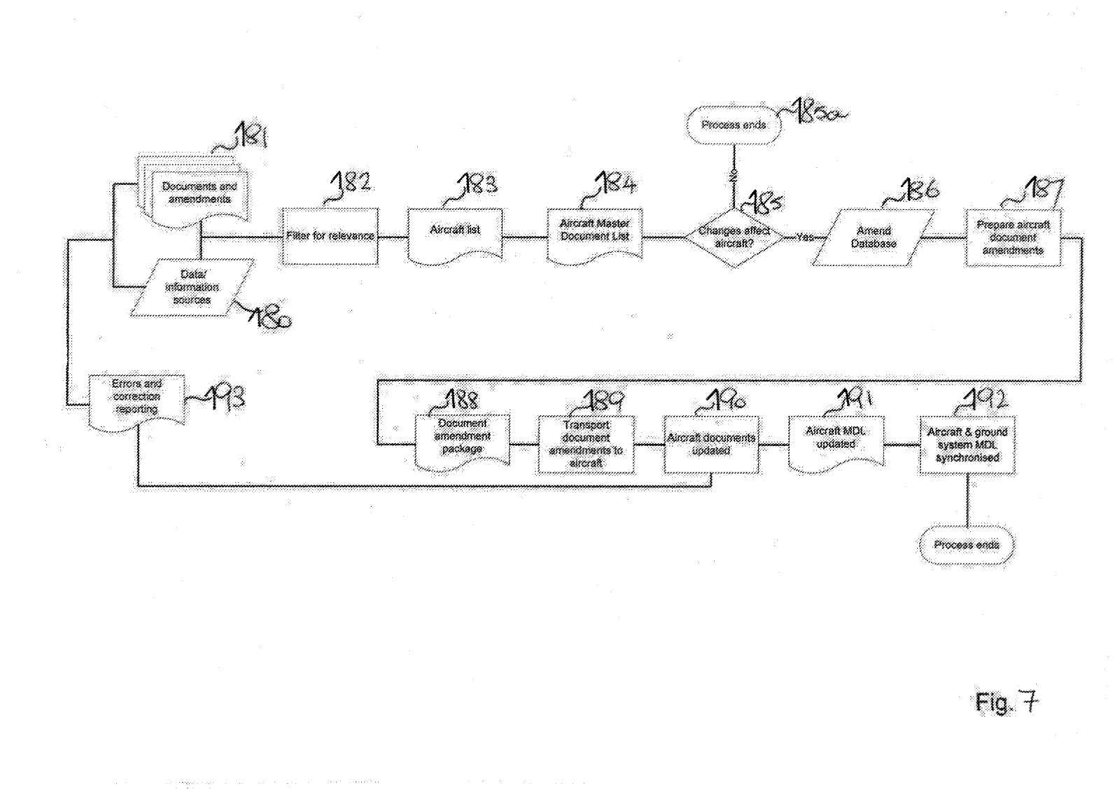

FIG. 7 illustrates a workflow diagram relating to the receipt of documents and amendments.

FIG. 1 shows an operational diagram of a flight information exchange system 10 which will also be referred to as advanced mission display system (AMDS).

Airborne components of the flight information system are provided on an aircraft 11. The airborne components include, among others, one or more displays, a computer, means for communication and data exchange and on board applications and data which are stored on a computer readable medium.

A first satellite communication link 12 connects the airborne components of the flight information system 10 to a satellite 13. The satellite 13 forms part of a network of satellites which are arranged to provide a global coverage of satellite communication links, such as the Iridium network. A second satellite communication link 15 is provided between a data centre 14 and the satellite 13. The connection between the data centre 14 and the satellite may involve intermediate nodes, for example of an aeronautical telecommunication network, which are not shown in FIG. 1.

The data centre 14 is connected to an operations support centre 9. Airport communication links 16 are provided between the data centre 14 and airports 17. The airport communication links 16 comprise a first secure internet connection 18. Airline communication links 19 are provided between the data centre 14 and airline offices 20. The airline communication links 19 comprise a second secure internet connection 21.

Furthermore, a Bluetooth data link 22 is provided between an antenna 23 at an airport 17 and the aircraft 11. The Bluetooth data link 22 serves to connect the aircraft 11 to the data centre 14 via the airport communication link 16 while the aircraft 11 is on ground.

FIG. 2 shows a data exchange diagram between ground-based and airborne components of the flight information system 10. The ground-based components comprise an operations centre 31, a communications gateway system 32 and airline information providers 33. An airborne system 34 is located on the aircraft 11, which is not shown in FIG. 2. It comprises a storage 35 for static data, onboard applications 36 and communication means 37. The communication means 37 include various communication devices for establishing connections such as a USB connection, a connection via a global satellite network or a secure Bluetooth connection. Furthermore, the airborne system 34 comprises a connection to an internal databus of the aircraft 11 for determining the status of the aircraft 11, for example to determine whether the engines of the aircraft 11 are running or if they are stopped. The airborne system 34 also comprises a graphical display and an input means for accepting user input such as a keyboard or a touch screen.

The operations centre 31 has interfaces 40, 41, 42, 43 for obtaining flight navigation data, Notices to Airmen (NOTAM), weather data and airline data, respectively. A further interface 44 is provided for exchanging information via an aeronautical fixed telecommunications network (AFTN) or via an aeronautical telecommunications network (ATN). The information comprises, for example, flight plans and other air traffic services messages to air traffic services, such as change or delay messages (FPL, CHG, DLA etc to ATS), and data to and from a central flow management unit (CFMU), etc.

Various communication channels are provided for interchanging data between the operations centre 31 and the airborne system 34. The various types of data which are exchanged via the communication channels between the operations centre 31 and the airborne system 34 include, among others, flight crew briefing packages 45, load sheets 46, NOTAM and weather (WX) updates 47. Specifically, an update channel 48 is provided for exchanging AIRAC (aeronautical information regulation and control) updates, Route Manuals and further data. A distribution channel 49 is provided for distributing flight planning data and any changes to that data to the ground system 31 after a flight plan has been produced onboard the aircraft 11.

The data centre 14 receives flight navigation data and information (Navdata) over the interface 40 from various sources including data and information for navigational and other purposes. A flight planning application onboard the aircraft 11 uses the flight navigation data and information to compute a flight plan for the aircraft 11.

The data centre 14 receives the navigation and information from State and/or other authorized sources, such as Route Manuals. The navigation data and information comprises details relating to facilities, services, rules, regulations and procedures, locations, airspace, routes, waypoints and turning points, radio navigation aids or systems, aerodromes, terrain data and obstacles.

FIG. 3 shows a data exchange diagram of a flight planning system 50, which is part of the flight information system 10 on board the aircraft 11. The flight planning system 50 comprises a flight planning unit 51 which is realized as one of the onboard applications 36 the airborne system 34 of FIG. 2. The flight planning unit 51 is connected to a main data assembly 52 via a secure channel 33. A main database 54 of the main data assembly 52 is connected to an external data source 35 and an airline data source 56.

The flight planning unit 51 comprises a user interface 58, a data output interface 59, a flight planning engine 60 that includes a flight route optimizer 61. Output from the flight planning unit 51 comprises, amongst others, a flight crew briefing package which comprises an operational flight plan, NOTAM and weather information relating to the flight, the air traffic services notification of the flight, which is known as a flight plan (FPL), the operational flight plan for use by the flight crew and for distribution to the airline and to the operations centre 31, a fuel calculation and data for a fuel order, a load sheet and loading instructions.

The flight planning unit 51 obtains input data via the secure channel 53. The input data which is provided by the ground-based components to the airborne system 34 may include data published by the airline's commercial scheduling department, engineering and maintenance, crew management, loading data relating to the expected number of passengers, and expected freight and cargo load, navigational data, including over flight permissions, aircraft specific data, including the Minimum Equipment List (MEL) status of the aircraft 11, and NOTAM and weather data and information. The flight planning unit 51 uses the flight planning engine 60 to generate flight related output data from the input data. The flight related output data comprise an operational flight plan (OFP), an ATS flight plan (FPL), a flight crew briefing package (FCBP), data for a fuel order, and information for an onboard load sheet application. After generation of the flight related output data, the flight planning unit 51 publishes and distributes the flight related output data to various airborne and ground-based applications and devices.

The flight planning unit 51 comprises various modules for performing the various calculation tasks that are required for generating a flight plan. Namely, the flight planning unit 51 comprises a flight route calculation and generation module, a flight route optimization module, a fuel calculation module and a cost calculation module.

Furthermore, the flight planning unit 51 comprises a crew briefing generation module and a message generation module for generating messages in standardized output formats such as OFP and FPL formats. The data in the standardized output format may then be displayed on board and it may be transmitted to the ground based system or to air traffic services and other agencies where it can be read and processed.

FIG. 4 shows a generation process for mission data subsets. Mission data subsets are the data and information which refers to a particular flight or mission of an aircraft and which is stored in the main data assembly 52 of the ground-based component. A mission data subset is passed to the aircraft based system 34 by Bluetooth or satellite or portable data carrier such as a USB device. The flight planning application 36 in the aircraft based component 34 of the flight information system 10 reads in and processes the mission data subset using the flight planning engine 51 and the various modules contained therein.

Input data, which the ground based component of the flight information system provides, includes flight navigation data 40, NOTAM 41, weather data 42, airline data 43 and information from a central flow management unit (CFMU). The above-mentioned types of input data can be characterised as follows.

Flight navigation data and information 40 is published by a State, for example in the form of an integrated aeronautical publication (IAIP). The IAIP may comprise a basic AIP with amendments, AIP supplements (AIP SUP), NOTAM, and aeronautical information circulars (AIC). The navigation data and information 40 comprises furthermore data and information from Route Manual providers. A Route Manual comprises a collection and compilation of information that is generally made up of data and information of various States.

Notices to Airmen (NOTAM) are issued by a State and distributed by means of telecommunication networks such as the AFTN and ATN. A NOTAM comprises information concerning the establishment, condition or change in any aeronautical facility, service, procedure or hazard. The NOTAM is a means of amending information published by a State in an AIP. The amendment may concern short time or also permanent changes. NOTAM are usually originated by a State and issued promptly whenever the information is temporary and of short duration or when operationally significant permanent changes or temporary changes of long duration are made at short notice, except for extensive text and/or graphics.

Information concerning snow, slush, ice and standing water on an aerodrome or heliport pavement is comprised in a special type of NOTAM called SNOWTAM. Likewise, information concerning an operationally significant change of volcanic activity, a volcanic eruption and/or volcanic ash is comprised in special type of NOTAM called ASHTAM. For the purposes of this application, SNOWTAM and ASHTAM are considered in the same way as NOTAM.

Weather data and information is published by an authorised source and comprises data and information reports of actual weather conditions such as METAR or SPECI messages, or forecasts such as TAF messages or meteorological advice and warnings such as SIGMET, prognostic charts wind and temperature charts and data in gridded binary (GRIB) format. The weather data and information may be encoded by an international weather code. The weather data and information describe weather conditions that have been reported by an authorised observer at an aerodrome or weather forecasts for an aerodrome, along a route or in an area. The weather data and information may also comprise advice or warnings which relate to significant weather conditions at an aerodrome, along a route or in an area.

The airline data comprises data and information that relates to the operation of a flight. It comprises, among others, loading information, engineering and maintenance data such as the MEL status, aircraft performance factors, information regarding the airline schedule and flight information relating to the technical crew and the cabin crew.

Further input data comprises flow management data from a flow management unit (CFMU). The flow management data comprises required departure, arrival, waypoint and boundary crossing times for a flight of an aircraft. The further input data also comprises air traffic service (ATS) data and information from an air traffic control agency. The ATS data may specify a definition of a track to be flown in relation to a system of organised or flexible tracks which are published on a regular basis. Track definition data, for example the Pacific Organised Track System (PACOTS) is used to define the routes available to flights on a particular date and time.

In a first step 71, the ground-based component of the flight information system receives input data such as navigation data 40, NOTAM 41, weather data 42, airline data 43 and information from the flow management unit (CFMU) or other input data.

In a second step 72, the input data is processed by the ground-component of the flight information system.

In a third step 73, the ground based component stores the processed input data in the main database 54 shown in FIG. 3.

In a fourth step 74, data in the main database 54 is sorted and grouped in accordance with relevance to the airline data 56 relating to the commercial, technical, engineering, regulatory and personnel areas of the airline.

In a fifth step 75 the sorted and grouped data is checked against a master document list (MDL) relating to the data and information that is already stored on the aircraft 11 and which has been synchronised with the MDL in the ground-based system so as not to duplicate data and information that is already onboard the aircraft 11.

In a sixth step 76, a flight or mission specific subset is constructed by the ground-based system which in a seventh step 77 is then stored in a data subset main assembly area. The mission data subset is created by taking only that data that is required by a particular flight.

In an eighth step 78, the flight or mission specific subset is transferred to the aircraft based system 34 at a variable parameter time set by the airline using secure communications channels for use by an onboard application 36, specifically the flight planning application 51.

In a ninth step 79, the data is accepted or rejected by the aircraft-based system for use by the aircraft-based applications 36.

In a tenth step 80, the aircraft and ground-based systems are synchronised using communications connections 37 so that the ground-based system has an up-to-date knowledge of the data and information that is onboard the aircraft 11. A completion of a cycle of data generation and synchronization of onboard data is marked in FIG. 4 by a process end step 81.

As mentioned previously, part of the data and information in the main database 54 is sub-divided into mission data subsets according to the sixth step of FIG. 4. The mission data subset is then transferred to the aircraft based system 34. Onboard applications 36 of the flight planning system 51 use the mission data subset on the aircraft 11 and combine this data subset with data and information already held by the onboard application's database such as the data and information contained in an AIRAC cycle update and the main static data load, and which is known by the ground-based system through the synchronisation process that takes place between the MDL in the aircraft-based system and the ground-based system for the creation of an operational flight plan (OFP), which is also known as navigational flight plan, and an air traffic services flight plan (FPL).

The OFP output is a result of a series of complex calculations made by the onboard application 34 and the flight planning engine 51, using the data and information provided to it during the data synchronisation and delivery process. The OFP provides the flight crew with specific details of the flight in relation to the route, including waypoints and turning points that the flight will take between the departure point and the destination, routes to alternate aerodromes, the times, tracks and distances between certain points along the route, the heights that the aircraft 11 will operate at, the amount of fuel required for the flight, the take-off and landing weights of the aircraft 11, details of the flight crew operating the flight, and other information specified by the flight crew for inclusion in the OFP. After the calculation of the OFP has been made by the flight planning engine 51, other onboard applications 34 receive information from the flight planning engine in relation to the amount of fuel required for the flight, and details relating to the loading of the aircraft 11 in the form of a Load Sheet and Loading Instructions. The communications connections 37 within the aircraft-based system enables outputs from the flight planning process and other onboard applications to send a fuel order and the Load Sheet and Loading Instructions to ground-based agencies, and for use in take-off performance calculations.

The FPL is an output of the flight plan from an application in an aircraft based component 34 of the flight information system 10 using the planning engine 60. The FPL provides a description of the flight as a notification advice to air traffic service and other aerodrome and en route providers. The FPL may be formatted according to a standard format such as provided by the ICAO, the FAA (Federal Aviation Administration) or other national organizations. The FPL data comprises an identification of the aircraft 11 conducting the flight, flight rules that the flight will operate to, a type of the flight, a number and type of the aircraft 11, a wake turbulence category, an equipment list, a departure aerodrome, a time of departure, cruising speeds and levels, a route, a destination, a total estimated elapsed time, an alternate aerodrome, a second alternate aerodrome and supplementary information, which includes details of the fuel currently on board.

FIG. 5 illustrates the processing of the mission data subset which has been generated according to FIG. 3 and FIG. 4 by an onboard component of the flight information system.

In a first step 90, the aircraft-based system 34 receives data and information as a mission data subset from the main database 54 via secure communications connection 53. This data subset, when accepted by the aircraft-based system, is utilised by the flight planning engine 51 which is one of the onboard applications 36 in the aircraft-based system, together with data held in the static data load 35. The flight planning engine commences its flight planning activities when required to do so by input from the flight crew via the user interface 58 or may be automatically activated by parameter settings in the flight planning application.

In a second step 91, the flight planning engine checks for company routes and stored routes to determine if full route planning is required or if candidate company or stored routes are available for the flight. In a decision step 92, it is decided if a suitable stored route is available, based on an examination of the flight schedule which is provided as part of the airline data and information 56 to determine the departure point, destination and the timings for the flight to take place.

If it is determined in the decision step 92 that candidate stored routes are available, the flight planning system continues the planning process through a sixth step 96. However, if candidate stored or company routes are not available, the process proceeds through a fourth step 93 to create proposed routes based on the flight schedule data from the mission data subset and using route and waypoint information from the navigation data provided either as part of the onboard static data load 35 or navigation data in the mission data subset. In this step 93, the creation of proposed candidate routes uses a horizontal optimisation algorithm, which considers the horizontal aspects of the flight in relation to aspects of the flight including, among other things, the departure point, the destination, distance, time, and cost.

In a fifth step 94, the flight planning system checks the proposed routes against the over-flight permissions held in the onboard data set to determine if the routes are acceptable or not. In a decision step 95, if no over-flight permissions are held for the proposed routes, the flight planning engine repeats the process through steps 93, 94, 95 until suitable proposed routes with respect to over-flight permissions are found.

In a sixth step 96, once proposed routes from the fourth step 93, or candidate routes from the second step 91 are accepted, the stored routes, the company routes or the proposed routes are checked against NOTAM information to determine if there are any restrictions or other considerations that need to be made with respect to the candidate or proposed routes. NOTAM that are provided as part of the mission data subset may be pre-processed so that the flight planning engine, when it ingests NOTAM for review against candidate or proposed routes, is alerted by means of a flag or other warning mechanism to highlight restrictions to the flight planning engine, and to reduce the processing effort and time for the onboard flight planning system.

In a seventh step 97, the stored routes, the company routes or the proposed routes are checked against weather information to determine if there are any warnings, restrictions or other considerations that need to be made with respect to the routes. In this seventh step 97, the flight planning engine 51 examines weather data that is contained in the mission data subset and determines the strength and the direction of actual and forecast wind records and the forecast precipitation and weather conditions and warnings such as those contained in SIGMET or warnings about the presence of volcanic ash. The flight planning engine 51 calculates a preferred route of flight taking into consideration headwinds and tailwinds and areas in which significant weather is known or forecast to exist. The flight planning engine 51 furthermore considers the weather at the destination and at alternate aerodromes to determine the need for, and the suitability of alternate aerodromes for the flight.

In an eighth step 98, the stored, company or proposed routes are considered against the performance data associated with the aircraft 11 to determine the suitability of the aircraft 11 for the routes, taking into consideration any aircraft limitations that may have been provided to the flight planning engine as part of engineering and maintenance data in the mission data subset, such as items with a limitation notified in the technical log, or the minimum equipment list (MEL).

In a ninth step 99, if the stored, company or proposed routes are acceptable, the candidate or proposed routes are passed to an eleventh step 101 within which the flight planning engine commences the calculation phase using the Calculation tools/Core System 60 of the flight planning engine 51.

In a tenth step 100, if the stored, company or proposed routes of the flight are not acceptable, the flight planning engine passes the rejection back to step 93 to determine if there are alternative stored or company routes, of to acquire other proposed routes for the flight. This ninth step 99 and tenth step 100 are iterative, including processing through steps 94, 95, 96, 97 and 98 until suitable routes are found.

In an eleventh step 101, the candidate or proposed routes for the flight are processed through a vertical optimisation algorithm to determine the most suitable route in terms of, amongst other things operating performance, fuel burn and cost, taking into consideration the winds and temperatures over the route of the flight using the GRIB data from the mission data subset, and other operational factors likely to affect the flight. In this eleventh step 101, fuel calculations are made with respect to the amount of fuel that may be required for the flight along the proposed routes between the departure point and the destination and to any alternate aerodromes required for operational or other considerations, calculations in relation to the amount of fuel required for the flight between specific points along a route, and calculations with respect to any reserves and/or contingency fuel and/or additional fuel. The flight planning engine 51 also calculates the required fuel for a given flight route, taking into account the aircraft's 11 specifications, the aircraft's 11 weight and the weather data. The weight of the aircraft includes the weight of the aircraft and the passenger and cargo weight, which is provided as a part of the mission data subset that is received as part of the airline data.

Furthermore, in the eleventh step 101, the flight planning engine makes calculations with respect to the costings for each candidate or proposed route to determine the most suitable route to be flown. These cost calculations include an assessment of the route in terms of airport charges, over-flight charges, the heights at which the aircraft 11 is proposed to be flown, the fuel required for the flight as calculated by the fuel calculation component of the flight planning system, the performance of the aircraft engines, and any other charges, taxes or levies likely to be imposed on the flight.

The calculations in the eleventh step 101 are carried out in an iterative process in which the candidate or proposed routes are optimised for vertical trajectories until a fully optimised route for the flight is determined. The flight optimisation module 61 evaluates the output from the flight planning process in terms of the expected gross weight of the aircraft 11 which is taken from the airline data, the weather conditions 42, including winds and temperatures, restrictions imposed by NOTAM and rules and regulations as well as the cruise parameters for long range cruise (LRC), the Mach Number or, alternatively, the indicated airspeed (IAS), the fuel policies and technical data provided by the airline, such as the performance characteristics of the aircraft 11. The flight optimisation module 61 carries out optimisations for each of the flight phases which comprise a departure taxiing phase, a take-off phase, a climb phase, a cruise phase, a descent phase, an approach phase, a landing phase and an arrival taxiing phase. The vertical optimization is carried out for each of the flight phases to determine the most appropriate heights to operate at after consideration of the take-off weight of the aircraft 11, the climb and cruise performance, headwinds or tailwinds and other operational factors, such as restrictions imposed by air traffic control or a flow management unit.

The flight optimisation module 61 carries out the vertical optimisation taking into account the fuel carried onboard, performance information provided by the airline, such as the rate at which the engines burn the fuel, the company fuel policies, the aircraft performance and the time the aircraft 11 is scheduled to arrive at the destination. The vertical optimisation calculates an optimal height to fly during each of the flight phases and also calculates the most efficient speed of the aircraft 11.

In the twelfth step 102, the most fully optimised is selected and presented to the flight crew for acceptance or for other input should they wish to do so.

In a thirteenth step 103, the results are formed into a predetermined format for the OFP and the FPL and creates an output OFP and FPL. The output from the flight planning process is presented to the flight crew via the Pilot Terminal Unit (PTU. The flight crew are able to view a graphical depiction of the route of the planned flight and to accept the flight plan, or to make alterations to it using the input facilities provided by either the onscreen keyboard, or via a separate keyboard device.

In this thirteenth step 103, the output from the flight planning engine is formatted as a flight crew briefing package which contains a copy of the OFP, NOTAM and weather information appropriate to the route of the flight and may be shown in either a graphical or a text format. In a fourteenth step 104, the OFP and the FPL are sent via the communications connections to the airline operating company, air traffic services and other providers. Output data from the flight planning engine including, the fuel calculations which are used for the formulation by a further application 36 in the aircraft-based system 34 for the creation of a fuel order, data to be used in the construction of a load sheet and loading instructions by a further application 36 in the aircraft-based system, data to be used for take-off performance calculations by a further application 36 in the aircraft-based system 34, and data to be used to depict the route of the flight, and to depict NOTAM and weather conditions likely to be encountered by the flight by a moving map application which is a further application 36 in the aircraft-based system 34, are passed to these applications for further use and calculation.

With regard to the fuel order, the output from the fourteenth step 104 in relation to the fuel required for the flight is compared with the fuel remaining onboard the aircraft 11 to determine the fuel which must be uplifted to the aircraft 11. The fuel order is presented to the flight crew, such that the flight crew can make adjustments to the quantity required to uplift. After adjustments to the fuel quantity have been made if these are required, the flight crew sends the completed fuel order from the aircraft 11 to the communications link 22 to an antenna 23 at an airport 17 to the data centre 18 via secure internet connection 16 and then to the airline or the refuelling agent via secure internet connection 21. Authorisation of the fuel order is provided via a biometric or other security device in the aircraft-based system to ensure the message is properly authorised by the flight crew. Similarly, the Load Sheet and the Loading Instructions are authorised by the flight crew using the biometric or other security device prior to transmission. Each message sent from the aircraft-based system to the ground-based component is protected by encryption to prevent unauthorised access to the messages being exchanged.

In the step 104, the aircraft-based system 34 may use other applications 36 and the communications connections 37 to transmit information concerning the composition of the flight crew briefing package to the ground-based system for use with operational control and with a flight following application in the ground-based system 31. Furthermore, the aircraft-based system may use the communications connections 37, and the communications gateway 32 to transmit the FPL to air traffic services and other agencies requiring the information as determined by the route of the flight, and may use the communications connections 37 and the communications gateway 32 to transmit a fuel order to a re-fuelling agent or other person responsible for organising the loading of the fuel onto the aircraft 11, and for transmission of a load sheet and loading instructions to a load control organisation or to an airline, or to an agent responsible for the loading of the aircraft 11.

In this fourteenth step 104, outputs from the onboard flight planning process are synchronised with the ground-based system using communications connections 37, Bluetooth communications link 22 to an antenna 23 on an airport 17 to connect the output from the aircraft 11 to the data centre 14, and subsequently to the airline offices 20 and the operations centre 9.

The flight plan that has been created by the onboard flight planning system is able to be loaded into the flight management computer system of the aircraft using separate connections into the ARINC Bus system of the aircraft which is included in the distribution step 104. Once the output from the onboard flight planning system has been sent via the ARINC bus to other onboard flight management computer systems, these other flight management computer systems are able to read the flight plan and use the information contained therein, for example the route description, in association with the navigation and operation of the aircraft.

FIG. 6 illustrates data and information collection and compilation activities in the course of a flight planning process according to the application. NOTAM are received from data providers 174, and are processed for relevance in relation to specific aircraft or to specific routes flown by the airline. In a compilation step after the receipt of NOTAM, the ground-based system automatically compiles a Monthly AIRAC NOTAM Bulletin, which is a collection of long term or permanent NOTAM that generally have a lesser importance when compared to some other NOTAM received by the ground-based system 170, for example a long term NOTAM notifying a change to the radio callsign of an air traffic facility would generally have lesser importance when compared to one notifying a runway or a taxiway being unserviceable.

Compilation of the Monthly AIRAC NOTAM Bulletin by the ground-based system 170 is part of the data and information filtering process, and one that is closely aligned to the processes depicted in FIG. 4 which depict a further view of the collection, collation and construction of a mission data sub-set.

The mission data sub-set makes reference to the Monthly AIRAC NOTAM Bulletin which has been compiled by the ground-based system and distributed to aircraft for which the service provider has responsibility, and does not include those NOTAM included in the Monthly AIRAC Bulletin with the mission data sub-set as these have already been passed to the aircraft in a separate document in the processes depicted in FIG. 4 for the updating of various aircraft documentation. Monthly AIRAC NOTAM Bulletin are provided to the aircraft at a parameter time which is derived by the ground-based system by making reference to the published AIRAC date.

The overall effect of the Monthly AIRAC NOTAM Bulletin is to reduce the numbers of NOTAM forming part of the mission data sub-set and reducing the amount of detail of direct operational significance to be absorbed by the flight crew in a relatively short space of time before during flight preparation, and is therefore, a direct safety benefit to the operations of the airline.

FIG. 6 shows data flows between a ground based system, an aircraft based system and external agencies. In the following, the aircraft based system 34 is also referred to as aircraft based 170, as shown in FIG. 6.

FIG. 7 shows a workflow diagram relating to the receipt of documents and amendments and is related to the depiction in FIG. 4. In a collection step, documents and amendments 181 are compiled from various data and information sources 180. In a filtering step 182 the documents and amendments are examined for relevance using aircraft list 183 which is a list of all aircraft for which a service provider holds responsibility for maintaining electronic documentation and aeronautical data and information.

The aircraft list considers the changes against a number of pre-determined parameters such as the type of aircraft, types of flight, departure and destination points, routes and timings of the flight, and other factors of operational significance, including the time the information becomes current for use and the time at which the information expires and is no longer valid for use. The filtering step 183 also uses the aircraft master document list 184 held in the ground-based system. This master document list holds a record of all documents and data and information held on the aircraft-based system 171 for all aircraft 11 within the service provider's contract.

The changes, including the addition of new documents, are determined in a step 185 and if there are no changes affecting a particular aircraft, the process terminates in 185a. If the changes affect a particular aircraft, the database 186 in the ground-based system is amended. In a compilation step 187, an amendment package 188 is prepared by the ground-based system, which in a communications step 189 is provided to the aircraft-based system 171. The communications step 189 can be either via secure Bluetooth communications or via a USB device. The data and information and documents on the aircraft-based system are updated in step 190 and the aircraft master document list updated in step 191 to reflect the changed content on the aircraft-based system. In a synchronisation step 192, the master document list on the aircraft-based system 171 is synchronised with the master document list held on the ground-based system 170.

In a further subsequent step, the flight crew are able to advise the ground-based system of any errors or omissions or other corrections required in an error correction and reporting step 193.

An example of a data update process according to the application is a change to a route manual. A route manual is a composition of documents and maps and charts, which a flight crew use during flight in connection with the operation of an aircraft. The route manual is subject to review and update each 28 days in accordance with a published schedule of predetermined dates known as the Aeronautical Information Regulation and Control or AIRAC Cycle, and is a schedule published by the International Civil Aviation Organisation (ICAO). The purpose of the AIRAC Cycle is to provide a regularised date on which aeronautical information publication documents are updated worldwide. Aeronautical Information Publication or AIP documents are published by each country (a State) that is a contracting State to the Chicago Convention on International Civil Aviation. Publication of the AIRAC Cycle dates allows data compilers such as those publishing route manuals or other data for the flight management systems onboard an aircraft to be properly planned and distributed to ensure any changes are made known to airline operators in advance of the date that the changes come into effect.

For example, a state changes the way a departure track is to be flown when departing from a particular runway at a particular aerodrome. This change is made firstly in the AIP of the country. Companies providing route manuals monitor changes made by States and, if the aerodrome is one that is included in a route manual that they produce, introduce a change to the contents of the route manual. The change to the route manual is the first step in the process shown in FIG. 4 at the collection and compilation step 181, after the changes have been received from data and information sources 180. In this case, the only change required to the route manual applies to one departure chart for one aerodrome. The filtering processes at 182 and the aircraft list 183 show that there are several aircraft 11 which fly to that aerodrome and who will require the changed chart 185. The ground-based system amends the database 186 with the change in relation to those aircraft requiring the change and prepares the chart to be sent to the aircraft in step 187 in the form of a document amendment package 188, which identifies which aircraft 11 are to receive the changes. The data amendment package 188 is also created in recognition of the date/time that the changes will take place and only sends the amendment package to the aircraft when the change is imminent. In the step 189, the document amendment package is transported to the aircraft either electronically via a USB device or via a Bluetooth data link 22. The aircraft-based system 171 accepts (or rejects) the data amendment package after the data package has been delivered to the aircraft-based system 171 and updates the aircraft documents. The aircraft-based system 171 then determines from the date of the amendment when the change is due to become effective and the time when the change is not longer valid (the temporality of the data) to become current and makes the changed document available to the flight crew at the correct time. The aircraft-based master document list 184 is updated in step 191 and synchronised with the ground-based system 170 in step 192.

A similar example of the update and synchronisation process is in the form of electronic data, which is used to update a moving map display in the cockpit display units 162 and 163.

The process flow is the same as for a route manual chart however, in this case for a data-driven display, a document is not provided in the update process, but the data that represents the changes are provided to the aircraft-based system 171. This updating process is used in connection with data objects resident in a geo-referenced moving map display, such as in conjunction with the display of weather features against a geographical background.

In all cases, the data or document flow is protected during transit and storage to ensure that the integrity of the data or documents is unchanged thus meeting specific international standards for the protection of aeronautical data and information while in transit or storage. This protection process is in place to ensure that the data being provided to the aircraft-based system is not altered in any way during the transmission. If the aircraft-based system detects that the data has been corrupted or changed by reference to the encryption algorithm, the data change is rejected by the aircraft-based system.

In a further example, an operational flight plan (OFP) and a flight crew briefing package (FCBP) are created by an onboard application 36 within the aircraft-based system 171 on the aircraft 11, using the cockpit display units 162 and 163 and the associated user interfaces. The flight planning application 36 draws on data and information passed to it as part of a mission data sub-set, including weather information and NOTAM to create an OFP and the FCBP. The mission data sub-set is created from a main database 54 located in the main data assembly area 52. Data and information contained in the main data is taken from the external data sources 31 which is made up of data and information contained in NOTAM, weather data, navigation data, and other operational data such as slot times from a flow management unit, or track definition messages, and from data and information provided by the airline such as crew information, information regarding the schedule of flights and the timetable for these flights to take place, data and information from engineering and maintenance, and other information required and useful for the conduct of a flight.

After the OFP and FCBP have been created, the outputs are provided to the flight crew via the cockpit display units 162 and 163, and are sent to the ground-based system 170 via the data and information processing and synchronisation device 176 and the aircraft-based communications device 175 to the ground-based communications device 173, which in turn passes the data and information to the data and information processing and synchronisation device in the ground-based system 170 and to those external agencies 169 requiring the information, including transmission via the AFTN and ATN communications links 44 to air traffic control and other agencies requiring the information.

The data and information processing and synchronisation device updates the flight profile of the aircraft's operation with regard to the timing of the flight and the information that is contained in the FCBP as part of the content inventory management processes. When new or amended NOTAM or weather information is received by the ground-based system 170 from data providers 174, or from other external agencies 169, the new or amended data and information is analysed and compared with that held and being used by the various flights under the operational watch.

Data and information received by the ground-based system from data providers 174 or external agencies 169 is in a first step analysed by the ground-based system in terms of checks of reasonableness, completeness and accuracy and in a second step analysed in relation to the aircraft list 183 which is a listing of all aircraft under operational surveillance by the service provider or the airline. The aircraft list considers the changes against a number of pre-determined parameters such as the type of aircraft, type of flight, departure and destination points, the route of the flight, the timing that the flight will take place, and the time that the data and information becomes current and the time that the data and information ceases to be current, for example a weather forecast or a NOTAM for a specific time period. This analysis step is one normally made by within an airline back office or other organisation providing a flight following service. If a change to the data or information held on an aircraft is considered likely to affect the continuing operations of a flight, the new or changed data or information is passed to the aircraft 11 using the ground-based communications device 173 to the aircraft-based communications device 175 and so on to the cockpit display units 162 and 163.

Only that information required by a specific flight is sent to the aircraft 11 concerned, and at a time when the information is required. The ground-based 170 system provides information to the aircraft-based system 171 based on the temporality of the information. This part of the updating and synchronisation process is accomplished using secure communications and encryption tools in the ground-based and aircraft-based systems. When data or information is considered as being required by a flight, the ground-based system applies the public keys of the related aircraft to the data and information update package.

The aircraft list 183 contains a listing of the particular address of each aircraft including the Bluetooth communications address and the IMEI of the airborne system if the communications for an airborne update are to be sent via satellite communications connections 12 and 15 from an aircraft 11 to a satellite 22. When the data and information arrives at the aircraft, the aircraft-based system 171 applies the private key held by the aircraft-based system 171 to decrypt the data and information and permit the entry of the data and information into the aircraft-based system 171. Use of the encryption private key held on the aircraft means that only information of interest to a specific flight could be read by the aircraft-based system 171.

The flight crew usually make en route reports to air traffic services providers and to their operating company to provide updates of the progress of the flight, which includes the present position of the aircraft 11, fuel remaining, and in some cases an airborne weather report. The flight crew use applications 36 in the aircraft-based system 34, the cockpit display units 162 and 163, and appropriate pilot interfaces such as the keypad on the touch-screen of the cockpit display units 162 and 163, or the separate keyboard to construct an en route report based on information extracted from other aircraft-based systems. After construction of an en route report, the flight crew transmit the report from the aircraft-based system 171 to the ground-based system 170 using the data and information processing and synchronisation device 176, the aircraft-based communications device 175 to the ground-based communications device 173, to the data and information processing and synchronisation device 172 and to external agencies 169.

If an airline has a need for additional reports, the aircraft-based system 171 uses the onboard communications capability and applications to generate automatic en route reports to the ground-based system for the purposes of flight following or operational monitoring of the flight. Onboard applications 36 in an aircraft 11 construct reports at predetermined parameter times describing the geographical location of the aircraft as coordinate values. These values are transmitted from the aircraft 11 using communications connections 12 and 15 to satellite 13 and from the satellite to the service provider's data centre 14 via communications connection 15. These coordinate values are used to plot the progress of the flight from departure point to destination.

The data and information processing and synchronisation device updates the progress of the flight in the ground-based system 170 which analyses the position of the aircraft and correlates this positional information with other data and information received from data providers 174 or other external agencies 169 so as to ensure the latest information is available to that part of the ground-based system 170 providing operational surveillance and information updating to the flight.

After the analysis has been completed, updates are sent back to the aircraft 11 on an as required basis, using the process described earlier and via the satellite communications connections 12 and 15 from an aircraft 11 to satellite 13 if these are required based on the information received through the in-flight reports, such as an amended time of arrival, or a change to the route of the flight made en route to divert around weather or on the basis of an air traffic control instruction.

After a flight plan (FPL) has been dispatched from the ground-based system 170 to air traffic services and other providers via the AFTN and/or ATN 44, the ground-based system monitors the progress of the flight in relation to the estimated time of departure (ETD) shown in the flight plan. Applications 36 in the aircraft-based system 171 monitor the ETD of the in terms of adherence to the ETD and determine the requirement for the flight planning application to create a delay (DLA), or cancellation (CNL) or other message type such as a change message (CHG)if there are alterations to the previous flight plan in accordance with the standards and recommended practices prescribed by the ICAO, for example if a flight is delayed more than 30 minutes beyond the ETD shown in the FPL, the onboard applications create a DLA message and sends, after confirmation by the flight crew, to the ground-based system via the communications connections 12 and 15 to the service provider's data centre 14, to the service provider operation support 9, to the customer airline 20 and to air traffic services and other service providers such as a central flow management unit (CFMU) via AFTN and ATN 44.

The onboard applications 36 provide similar functionality to create and dispatch a modification or change message (CHG) when this is required by a change to parts of the dispatched FPL. In this case, if the aircraft-based system has received an update to the weather or NOTAM information after the initial FPL has been created and a new flight plan is required, to amend an earlier version, because there are significant weather conditions en route that require a change of routing, or if a NOTAM activates or deactivates a warning or restricted area which either precludes the use of a route, or in the case of a deactivation, enables the use of a route not previously available, the flight planning application in the onboard applications 36 creates the new FPL and OFP, presents these to the flight crew via the cockpit display units 162 and 163, and sends the appropriate messages, in this example a CHG, to those requiring notification via the communications connections 12, 15 to the service provider's data centre and to the message addressees via AFTN or ATN 44.

A similar situation exists for the creation and dispatch of a cancellation message (CNL) if the flight is unable to proceed, and the flight is cancelled. In the preceding examples for DLA, CHG and CNL messages, these are all messages normally originated as part of airline back office functionality.

DLA, CNL and CHG messages are also sent to the ground-based system 170 as part of the synchronisation of messages and content inventory between the aircraft-based and ground-based systems using the process flow in shown in FIG. 3.

The ground-based system 170 is responsible for the management and operation of communications links and interfaces used to support the provision of operational data and information, and for the transmission of flight plans (and related ATS messages) to air traffic services agencies responsible for providing terminal and en route air traffic services. These communications may include transmissions via TCP/IP, or the AFTN or the ATN.

In the case of the AFTN and ATN, each air traffic services unit or other similar type service provider, for example a flow management unit, has a specific address known to the AFTN and ATN. An AFTN address consists of eight alphabetical characters, which signify the flight information region, the location the facility is located in, and, the department or section in the facility. For example, an AFTN address for Singapore, Changi Airport control tower may be WSSSZTZX, where WSSS is the indicator for Singapore, Changi Airport and ZTZX is the suffix for the control tower.

Applications 36 in the aircraft-based system 171, and similar flight planning applications in the ground-based system 170, more specifically the flight planning application, when compiling a flight plan for air traffic services, compiles a list of the flight information region (FIR) boundaries and shows these in the route section of the FPL. The route of the flight is determined by the flight planning application with reference to aeronautical data and information held by the aircraft-based or ground-based systems that is provided as part of the navigation data 40, airline data 43, and as altered by NOTAM 41. The flight planning application uses this aeronautical data and information during the construction phase of the OFP (and FPL). The flight planning application makes reference to the weather information 42 during the construction and optimisation phase of the flight planning process. At the end of the construction and optimisation processes OFP and FPL are produced. ICAO standards prescribe that FPL are required to be sent to a specific AFTN or ATN address for each FIR the flight will enter and to the control tower at the departure airport and the destination airport.

The ground-based system analyses the route of the flight after an FPL is received from the aircraft-based system and creates the required AFTN/ATN addressees by reference to the route structure. If additional addressees are required for a particular route, for example if an AFTN/ATN address is required for an en route military facility, these are held in the ground-based system and applied when required. After analysis of the route structure and application of the AFTN/ATN addressees, the ground-based system sends the FPL (and other associated messages such as CHG, DLA etc when these are required) to the communications connections 44 and subsequently for delivery via the AFTN or ATN to the message addressees.

In the case of other external agencies such as an airline, FPL and associated messages are sent via the service provider's data centre 14 to the airlines 20 using communications connections 41, 42 and 39 as described in the description of the Figures using and address such as an IP address, an email address, or an address allocated for use with the SITA communications network.

FIG. 7 illustrates a further aspect of the application in which the ground-based system 170 receives data and information from the airline 56, which includes data and information relating to crew management and is collated in a main database 54. Part of the data and information compiled into the main database 54 of the ground based system 170 and subsequently exchanged between the ground-based system 170 and the aircraft-based system 171 using the data and information processing and synchronisation devices 172 and 176 and the communications devices 173 and 175 relates to specific authorisations that the flight crew has in relation to the signing and authorisation of certain forms and documents.

After the crew information and the associated authorisations have been synchronised between the ground-based system and the aircraft-based system using the data and information processing devices 172 and 176 and communications connections 173 and 175, the flight crew sign in and report into the airline's crew management system through biometric devices (not shown in the figures) contained in the cockpit display units 162 and 163. When the flight crew have signed into the aircraft-based system, this information is communicated to the ground-based system using the aircraft-based devices 76 and 75 and the ground-based systems 73 and 72.

Signing on normally takes place during a separate process with the airline back office before the flight crew board the aircraft. Signing on using the aircraft-based system provides a further level of assurance that the correct flight crew are on the correct aircraft in readiness for the flight.

Sign-on into the aircraft-based system then provides applications 36 in the aircraft-based system with the means to check the flight crew are properly authorised for the flight in terms of aspects such as the currency of their medical certification, recency with regard to certain airports, certain types of flights, for example Category 3 landings, and in certain types of aircraft such as wide-bodied and narrow-bodied aircraft, for flight and duty times.

Onboard applications 36 in the aircraft-based system 34 make reference to the flight crew sign-in and are able to determine from the data and information received from the ground-based system as part of the mission data sub-set and the synchronisation process, and as part of the data and information received from the airline data stream 19, who is responsible and accountable for the authorisation of specific activities onboard the aircraft, for example the flight commander has specific regulatory responsibilities and accountabilities that the first or second officer may not hold.

In a continuation of the foregoing example, once the flight crew has signed into the aircraft-based systems 171 using the biometric or other authorisation method such as a password, onboard applications 36 such as the flight planning application, Fuel Order and the Load Sheet and Loading Instructions generators 36 facilitate the construction of various forms and documents which require authorisation in accordance with regulatory requirements or company policies, for example, defect Lists and entries in the Technical Log and Fuel Orders must be properly authorised, and Load Sheets must be signed and retained by the ground handling agents before the flight departs. The authorisation process uses the flight crew sign-in as described in the preceding paragraphs as a means of verifying that documents, forms or entries in a Technical Log have received the required authorisation from the responsible flight crew member.

In one embodiment, examples such as Fuel Orders and Loading Sheets and Loading Instructions are created using onboard applications 36, are authorised by reference to the biometric or password sign-in used by the flight crew, and are communicated between the aircraft-based system 171 and the ground-based system 170 using the devices 176 and 175 on the aircraft-based system, and 173 and 172 on the ground-based system, and in a subsequent step communicated with external agencies 169, which supersedes and replaces the manual processes currently in place for the preparation, presentation, authorisation and communication of the Fuel Orders, Load Sheets and Loading Instructions between the flight crew and the ground handling agents.

After fuelling of the aircraft has taken place, fuel invoices are able to be uplinked to the aircraft-based system 171 using the communications connections from the external agencies 169 to the ground-based devices 73 and 72, to the aircraft-based systems using the onboard devices 175 and 176. The fuel invoices and other loading information such as catering and water uplift are retained by the aircraft-based system 171 for compilation of the voyage report.

At the conclusion of a flight, the flight crew create a Voyage Report to report on the progress and conduct of the flight. A Voyage Report is normally created using a paper-based form and left for the ground handling agents to collect prior to the next flight. In this embodiment, onboard applications 36 in the aircraft-based system 34 automatically compiles a Voyage Report using data and information collected from various other systems on the aircraft such as reports from the OOOI which shows the time out and time in, from the Flight Crew sign-in, fuel used, the amount of fuel on departure and on arrival, fuel uplift, and other details which describe the flight in terms of the route, flight times, delay codes, and the numbers of passengers.

Data and information collected and compiled into the Voyage Report is provided to the onboard applications 36 using the ARINC bus and other signal discrete on the aircraft. The data and information, when collated and compiled by an onboard application 36 in the aircraft-based system 34 is presented to the flight crew for authorisation using a biometric or other authorisation device and transmission to the ground-based system using the aircraft-based devices 176 and 175 and the ground-based device 173 and 172, and in a subsequent step to external agencies 169. Fuel orders and other cost related information such as catering, water and de-icing services are appended to the Voyage Report, which in turn provides the mechanisms for streamlined processing in the airline.

According to a further aspect of the application, the aircraft-based system 171 collects data and information from aircraft data sources collected from the aircraft data buses. In this way, the aircraft-based system acts as a virtual Quick Access Recorder (QAR). A QAR device on the aircraft is a recording device which collects data and information relating to the operation of the aircraft such as exceedance data and normally provided to the Flight Operations Quality Assurance (FOQA), but is also of use to other airline departments such as engineering and maintenance to review the operating aspects of the engines and other aircraft systems.

Flight related data and information collected from other aircraft systems is compiled within the aircraft-based system using an application 36, passed to the onboard devices 176 and 175 and sent to the ground-based system 170 via devices 173 and 172, and in a subsequent step to external agencies 169. The effect of this data and information transfer is that departments in the external agencies, such as the FOQA and engineering and maintenance departments are able to receive virtual QAR data and information far more rapidly using the secure Bluetooth communications connections 22 at an airport 35 or 36 using a parameter time for the data and information to be collected and sent after each flight or after a series of flights.

This means that internal airline departments such as FOQA and engineering and maintenance are able to take corrective and preventive action much faster than had they used the methods currently in place for the extraction and receipt of QAR data.

Further aspects of the application are given by the following list of items:
1. Method for generating a mission specific data subset for use in a flight planning application comprising the steps of:
   receiving flight related input data;
   processing the flight related input data;
   storing the processed data in a main database;
   sorting and grouping the processed data in the main database;
checking the sorted and grouped data against a master document list;
   updating the master document list;
   constructing a mission specific data subset from the master document list.
2. Method for the provision of output data by an onboard flight planning system for the composition and generation of a flight related document, the flight related document being selected from a Load Sheet, a Loading Instruction, and a Fuel order, comprising the steps of:
   receiving flight related input data from a mission data subset;
   processing flight related input data;
   generating output data for use by other applications in the aircraft-based system;
   compiling the output data into a pre-determined format to obtain the flight related document.
3. Method according to item 2, wherein the flight related document is one of a selection of a load sheet and a fuel order, and wherein the processing of the flight related input data further comprises a step of optimizing candidate routes, the step of optimizing the candidate routes further comprising the steps of:
   calculating a fuel consumption for the candidate routes;
   calculating a cost for the candidate routes based on the calculated fuel consumption (further factors are, for example, over-flight fees, airport taxes etc)
   selecting a flight route from the candidate routes, based on the calculated fuel consumption and the calculated cost and wherein the method further comprises a step of
   deriving the output data from the flight route.
4. Method according to item 2 or item 3, further comprising a step of
   comparing an amount of required fuel with an amount of fuel remaining onboard the aircraft 11 to determine an amount of fuel which must be uplifted to the aircraft 11.
5. Method, according to one of the items 2 to 4, further comprising the steps of
   formatting the output data;
   transmitting the formatted output data to one ore more external agencies, the external agencies being selected from an air traffic control service, an airline, a data service provider.
6. Method according to one of the items 2 to 5, furthermore comprising a step of
   authenticating the output data using biometric or other security devices prior to a step of dispatching the output data.
7. Method for generating output data by an onboard flight planning application, the method comprising the steps of
   calculating a most suitable flight route from a mission data subset by an onboard flight planning application;
   generating a formatted output in a predefined output format, based on the flight route, the formatted output being one of a selection of a flight plan, an operational flight plan, a flight crew briefing package, a load sheet, fuel calculation data, take-off performance data.
8. Method according to item 7, the method further comprising
   transferring the formatted output to a ground based system;
   using the formatted output to synchronize a database of the ground based system
9. Method according to item 8, the step of synchronizing further comprising:
   synchronizing a master document list, the master document list comprising an aircraft list.
10. Method for displaying output from an onboard flight planning application in a moving map application, the method comprising the steps of:
   generating output data from a mission data subset by an onboard flight planning application;
   retrieving a part of a planned flight route from the output data;
   displaying the part of the planned flight route in a moving map display of a cockpit display unit.
11. Method according to item 10, the method further comprising the steps of
   retrieving weather data from the mission data subset;
   displaying the relevant weather data in a moving map display on an aircraft using a moving map application;
12. Method according to claim 10, the method further comprising
   retrieving NOTAM from the mission data subset;
   displaying the relevant NOTAM in the moving map display using a moving map application.

Prior to display, the data may be filtered for relevance with regard to the planned flight route, with regard to the current aircraft position, with regard to a timestamp of the data and to other criteria.

### REFERENCE NUMBERS

9 operations support centre
10 flight information system
11 aircraft
12 satellite communication link
13 satellite
14 data centre
15 satellite communication link
16 airport communication link
17 airport
18 secure internet connection
19 airline communication links
20 airline offices
21 secure internet connection
22 Bluetooth data link
23 antenna
31 ground system
32 communications gateway system
33 airline information providers
34 airborne system
35 storage [number missing in drawing]
36 onboard applications
37 communication means
40 flight navigation data interface
41 NOTAM interface
42 weather data interface
43 airline data interface
44 AFTN/ATN interface
45 briefing packages
46 load sheets
47 NOTAM and weather updates
48 update channel
49 distribution channel
50 flight planning system
51 flight planning unit
52 main data assembly
53 secure channel
54 main database
56 airline data source
58 user interface
59 data output interface
60 flight planning engine
61 route optimizer
71 first step
72 second step
73 third step
74 fourth step
75 fifth step
76 sixth step
77 seventh step
78 eighth step
79 ninth step
80 tenth step
81 process end
90 first step
91 second step
92 decision step
93 fourth step
94 fifth step
95 decision step
96 sixth step
97 seventh step
98 eighth step
99 ninth step
100 tenth step
101 eleventh step
102 twelfth step
103 thirteenth step
104 fourteenth step
105 fifteenth step
162 cockpit display unit
163 cockpit display unit
169 external agencies
172 data and information processing and synchronisation device
173 ground based communication device
174 data providers
175 aircraft based communications device
176 data and information processing and synchronisation device
180 data and information sources
181 documents and amendments
182 filtering step
183 aircraft list
184 master document list
185 method step
185a termination step
186 database
187 compilation step
188 amendment package
189 communications step
190 method step
191 method step
192 synchronisation step
193 error correction and reporting step

1. Device for generating a flight route of an aircraft by an aircraft based computer system, comprising
means for receiving a mission specific data subset from a ground based system,
means for checking for predefined routes from a departure airport to a destination airport,
means for selecting the predefined routes as a set of candidate routes if predefined routes are available,
means for generating a set of proposed flight routes, the set comprising at least one proposed flight route if no predefined route is available,
means for checking over-flight permissions for the set of proposed flight routes;
means for repeating the steps of generating a set of proposed flight routes and of checking the over-flight permissions until at least one proposed flight route is found to be in accordance with the over-flight permissions;
means for selecting the at least one proposed flight route as a set of candidate routes;
means for deriving a flight route from the set of candidate routes.

2. Device according to claim 1, the device further comprising
means for calculating a fuel consumption for the candidate routes;
means for calculating a cost for the candidate routes based on the fuel consumption.

3. Device according to claim 1, further comprising
means for checking the candidate routes against weather data,
means for calculating a preferred route of flight based on the weather data.

4. Device according to claim 1, further comprising
means for loading the flight route into a flight management computer system of the aircraft for the generation of autopilot commands using an onboard databus system.

5. Device according to claim 1, further comprising
means for generating flight crew briefing package which contains a listing of NOTAM and weather, and other information relevant to the flight.

6. Aircraft based flight planning system comprising a device according to claim 1.

7. Aircraft with an aircraft based flight planning system according to claim 6.

8. Aircraft based flight planning system for generating a flight route of an aircraft by an aircraft based computer system, the aircraft based flight planning system comprising:
a receiving means for receiving a mission specific data subset from a ground system,
a computer readable memory for storing a set of predetermined routes and a set of predetermined overflight permissions,
a control means for determining if predetermined routes from a departure airport to a destination airport are available, the predetermined routes being stored in a computer readable memory, for outputting the predetermined routes as a set of candidate routes,
a flight route generating and calculation module for generating, if predefined routes are not available, a set of proposed flight routes, the set comprising at least one proposed flight route,
wherein the control means verifies for the set of proposed flight routes, for which of the proposed flight routes the over-flight permissions are fulfilled, and wherein the control means repeats the steps of generating a set of proposed flight routes and of verifying the over-flight permissions until at least one proposed flight route is found to be in accordance with the over-flight permissions, and wherein the control means outputs the proposed routes which are in accordance with the over-flight permission as a set of candidate routes, and wherein the control means derives a flight route from a set of candidate routes.

9. Method for generating a flight route of an aircraft by an aircraft based computer system, comprising the execution of the following steps by the aircraft based computer system:
receiving a mission specific data subset from a ground based system;
checking for predefined routes from a departure airport to a destination airport;
if it is determined that predefined routes are available:
using the predefined routes as a set of candidate routes;
if no predefined route is available:
generating a set of proposed flight routes, the set comprising at least one proposed flight route;
checking over-flight permissions for the set of proposed flight routes;
repeating the steps of generating a set of proposed flight routes and of checking the over-flight permissions until at least one proposed flight route is found to be in accordance with the over-flight permissions;
using the at least one proposed flight route as a set of candidate routes;
deriving a flight route from the set of candidate routes.

10. Method, according to claim 9, the method further comprising the steps of
determining the acceptability of the set of candidate routes according to a predetermined set of conditions;
if it is determined that none of the candidate routes is acceptable: repeating the following steps until at least one acceptable candidate route is found:
generating a new set of candidate routes;
repeating the steps of checking the over-flight permissions and of generating a set of proposed flight routes until at least one proposed flight route is found to be in accordance with the overflight permissions;
using the at least one proposed flight route as a set of candidate routes;
determining the acceptability of the set of candidate routes;
if it is determined that at least one candidate route is acceptable;
optimizing the acceptable candidate route vertically;
selecting a flight route from the acceptable candidate routes, based on output data of the optimizing step;
storing the flight route in a computer readable memory of the aircraft based system for later output.

11. Method according to claim 9, further comprising a step of
loading the flight route into a flight management computer system of the aircraft for the generation of autopilot commands using an ARINC Bus system.

12. Method according to claim 9, further comprising a step of
displaying the flight route in an onboard pilot display unit, the pilot display unit including a moving map display.

13. Method according to claim 9, further comprising the steps of:
calculating a fuel consumption for the candidate routes;
calculating a cost for the candidate routes based on the fuel consumption.

14. Method according to claim 9, further comprising a step of
generating flight crew briefing package which contains a listing of NOTAM and weather, and other information relevant to the flight.

15. Method according to claim 9, further comprising a step of
generating a mission specific output for use in automated flight following for the flight, the automated flight following comprising the steps of:
receiving the mission specific output data from the aircraft-based system by a ground based system;
storing the mission specific output data in a computerized flight following system;
analysing data being received by the ground-based system;
comparing and determining if the data being received by the ground-based system is different to the mission specific data output from the aircraft-based system;
automatically updating the data on board the aircraft if a change is required;
re-synchronising master document lists held on both the aircraft-based and ground-based systems.

16. Method according to claim 9, further comprising steps of
deriving formatted output data from an output of the flight planning application;
transmitting the formatted output to one ore more external agencies, the external agencies being selected from an air traffic control service, an airline, a service provider.

17. Method according to claim 9, wherein the set of predetermined conditions are updated based on the mission specific data subset, the updating comprising:
extracting data from the mission specific subset;
parsing the data from the mission specific subset;
deriving one ore more of the predetermined conditions from the parsed data.

18. Method according to claim 9 wherein the step of receiving the mission specific data set comprises
receiving the mission specific dataset via a Bluetooth connection.

19. Method according to claim 9 wherein the selection of the flight route comprises
calculating, for one or more of the candidate routes, the costings of the candidate route wherein the calculation comprises
retrieving or calculating charges,
retrieving or calculating performance data of the engines of the aircraft.

20. Method according to claim 10, wherein the determining of the acceptability of candidate routes comprises
checking the candidate routes against weather data,
calculating a preferred route of flight based on weather information.
